(19) United States
(12) Patent Application Publication
(10) Pub. No.: US 2026/0252284 A1
(43) Pub. Date: Aug. 27, 2026

(54) TECHNIQUE FOR CALCULATING ENERGY CONSUMPTION OF IMAGE FORMING APPARATUS

(71) Applicant: CANON KABUSHIKI KAISHA, Tokyo (JP)

(72) Inventor: AKIRA HANATANI, Chiba (JP)

(21) Appl. No.: 19/364,370

(22) Filed: Oct. 21, 2025

(30) Foreign Application Priority Data
Oct. 28, 2024 (JP) 2024-189203

(51) Int. Cl. G06F 3/12; G03G 15/00; G06F 1/3234

(52) U.S. Cl. CPC G06F 3/1221; G06F 1/3284; G06F 3/1229; G03G 15/5004

(57) ABSTRACT

An image forming apparatus comprises a board, an identification unit, and a computation unit. The identification unit identifies a type of the board. The computation unit acquires, from a storage unit storing a plurality of pieces of power consumption information in correspondence with a plurality of different types of boards, power consumption information corresponding to the type of the board identified by the identification unit, and calculates an energy consumption of the image forming apparatus based on the acquired power consumption information.

### BACKGROUND

### Field of the Technology

The present disclosure relates to technology for calculating the energy consumption of an image forming apparatus.

### Description of the Related Art

In recent years, green transformation (GX) has emerged as an issue for companies. As a result, there is an increasing need to visualize the power consumption of image forming apparatuses such as multifunction printers (MFPs). Japanese Patent Laid-Open No. 2012-158157 proposes using a sensor to detect alternating current supplied from a power supply, and displaying the detection result.

Various image forming apparatuses that can print different numbers of sheets per unit of time (i.e., have different productivities) are sold on the market. In this case, in order to improve the efficiency of development, platform-type development has been adopted in which hardware is used in common among image forming apparatuses that have different productivities. For example, the number of application specific integrated circuits (ASICs) implemented on a control board is changed to match the required productivity. As a result, various types of boards are produced, resulting in differences in power consumption values. When a current sensor is implemented on a board, the energy consumption of the image forming apparatus can be accurately calculated, but this leads to an increase in the manufacturing cost of the image forming apparatus.

### SUMMARY

The present disclosure provides an image forming apparatus comprising a board, an identification unit configured to identify a type of the board, and a computation unit configured to acquire, from a storage unit storing a plurality of pieces of power consumption information in correspondence with a plurality of different types of boards, power consumption information corresponding to the type of the board identified by the identification unit, and calculate an energy consumption of the image forming apparatus based on the acquired power consumption information.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1A is a diagram illustrating an image forming apparatus.

FIG. 1B is a diagram illustrating the image forming apparatus.

FIG. 2 is a diagram illustrating a user interface.

FIG. 3 is a state transition diagram regarding power states.

FIG. 4 is a diagram for describing an energy consumption adding method and cumulating method.

FIG. 5 is a diagram for describing the energy consumption adding method.

FIG. 6 is a block diagram illustrating functions of a computation unit.

FIG. 7 is a diagram illustrating a control unit.

FIGS. 8A to 8C are diagrams illustrating level switches.

FIG. 9 is a diagram illustrating a first table.

FIG. 10 is a diagram illustrating a second table.

FIGS. 11A and 11B are diagrams illustrating the energy consumption cumulating method.

FIG. 12 is a flowchart illustrating a control method.

FIGS. 13A to 13C are diagrams illustrating level switches.

FIGS. 14A and 14B are sequence diagrams illustrating processing for acquiring information from a server computer.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### 1. Image Forming Apparatus

In a first embodiment, descriptions will be given for a power consumption calculation method that takes into account the energization state of an optional device connected to an image forming apparatus, and a configuration for realizing the power consumption calculation method.

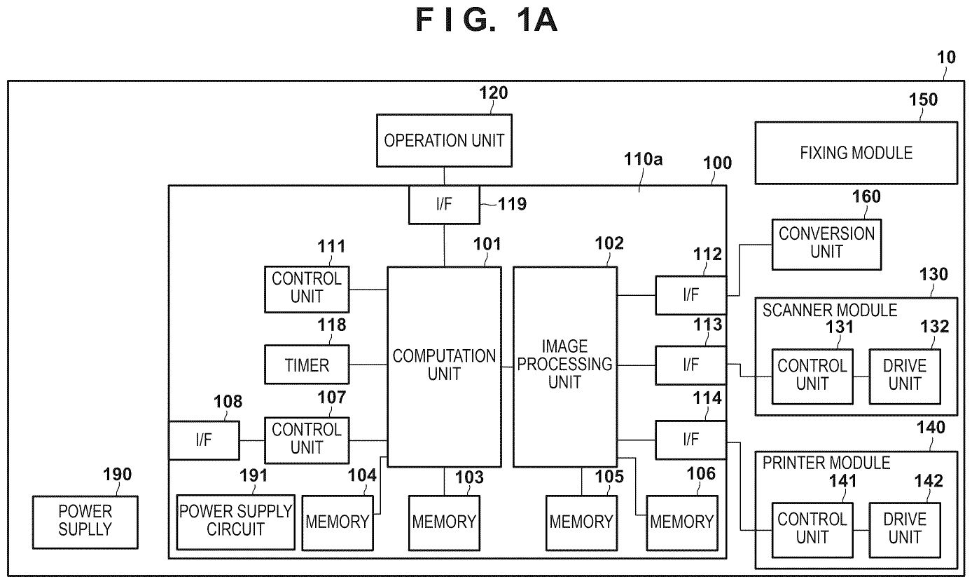

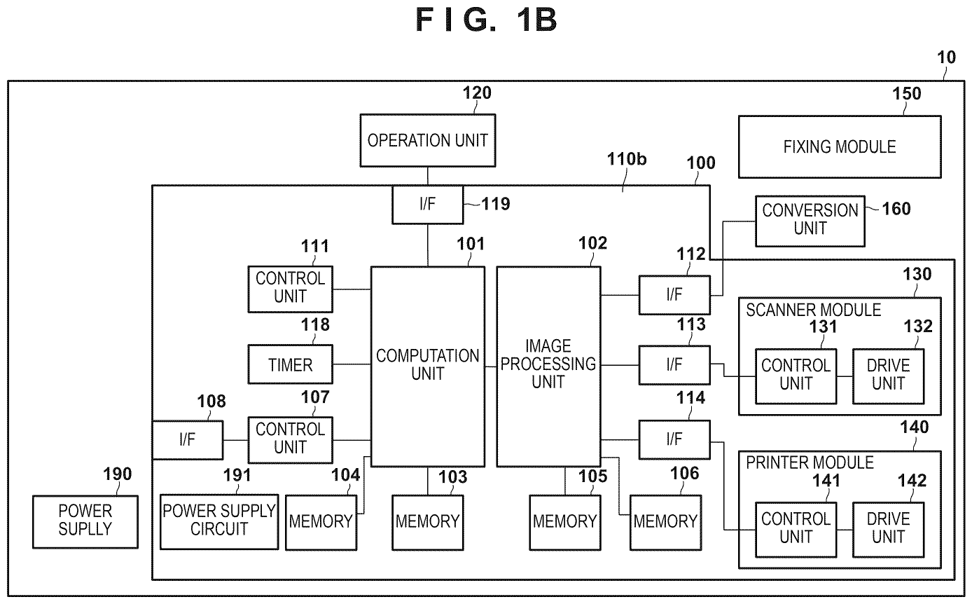

FIG. 1A is a diagram illustrating the configuration of an image forming apparatus 10 having a type A board 110a. The image forming apparatus 10 mainly includes a controller module 100, an operation unit 120, a scanner module 130, a printer module 140, and a fixing module 150.

The controller module 100 has the board 110a. Components implemented on the board 110a may include a computation unit 101, an image processing unit 102, memories 103 to 106, control units 107 and 111, I/Fs 108 and 112 to 114, a timer 118, and a power supply circuit 191. I/F is an abbreviation for “interface”, and may also be called a port, a connector, or a terminal according to the technical standard (e.g., the Universal Serial Bus standard).

The board 110a may be constituted by a single circuit board or a plurality of circuit boards. The computation unit 101 is a processor (e.g., a central processing unit (CPU)) that is responsible for controlling the power state of the image forming apparatus 10 and handling print jobs received from peripheral equipment (e.g., a personal computer (PC)). When the image forming apparatus 10 starts up, the computation unit 101 reads out a boot program stored in the memory 104, which is a non-volatile memory. The read program is deployed to the memory 103, which is a volatile memory. The boot program may be, for example, a basic input output system (BIOS), a boot loader, or an operating system (OS).

The non-volatile memory 104 is, for example, a read-only memory (ROM), an embedded multimedia card (eMMC), or the like. The non-volatile memory 104 may include a random access memory (RAM) that is a continuously powered by a battery. The volatile memory 103 includes, for example, a RAM. The RAM may be, for example, a dynamic RAM (DRAM). The volatile memory 103 is used as a work memory by the computation unit 101.

The computation unit 101 is connected to the control unit 107. The control unit 107 is a communication circuit that performs communication with peripheral equipment, such as a PC, via the I/F 108, which is a wired LAN interface. LAN is an abbreviation for Local Area Network. An RJ-45 standard connector is generally used as the I/F 108 for a wired LAN. Also, Transmission Control Protocol/Internet Protocol (TCP/IP) or the like is used as the communication protocol. The computation unit 101 and the control unit 107 are connected via, for example, a Peripheral Component Interconnect express (PCIe) bus. The control unit 107 is connected to the I/F 108.

When the PC transmits a print job to the image forming apparatus 10 via a wired LAN, the control unit 107 receives the print job and transfers the print job to the computation unit 101. The computation unit 101 outputs, to the image processing unit 102, instructions for driving the scanner module 130 and the printer module 140 in accordance with the print job.

The image processing unit 102 is a second processor and may be integrated with the computation unit 101. The image processing unit 102 performs image processing (e.g., noise removal, color conversion) on scanned data of an original received from the scanner module 130, and generates image data. The image processing unit 102 stores the image data in the non-volatile memory 106. The image processing unit 102 converts the input image data and transmits the converted data to the printer module 140. Here, the format of the image data is converted into a format readable by the printer module 140. In this way, a duplicate of the original is realized. The image data acquired by the scanner module 130 is bitmap data in a red-green-blue (RGB) format. Also, the printer module 140 forms images on a recording medium using yellow, magenta, cyan, and black (YMCK) toner or ink. Therefore, the image processing unit 102 needs to execute color conversion. The image processing unit 102 and the scanner module 130 are connected via the I/F 113. The image processing unit 102 and the printer module 140 are connected via the I/F 114.

The image processing unit 102 has the volatile memory 105 that functions as a work memory. The non-volatile memory 106 may include, for example, a ROM and a solid-state drive (SSD).

The image forming apparatus 10 can be connected to a printer server (not shown). This enables jobs created for respective users to be executed in cooperation with a workflow system. The printer server is connected to the controller module 100 via a conversion unit 160. The conversion unit 160 is a communication conversion circuit for enabling the image forming apparatus 10 to perform communication with a server computer. The conversion unit 160 is connected to the image processing unit 102 via the I/F 112. The conversion unit 160 converts the format of image data received from the printer server into a format readable by the image processing unit 102. The printer server and the conversion unit 160 are both optional devices, or the conversion unit 160 is an optional device. While the image forming apparatus 10 is in operation, connection of the printer server and the conversion unit 160 to the controller module 100 is prohibited, and removal of the printer server and the conversion unit 160 from the controller module 100 is prohibited.

The controller module 100 has the timer 118 that is connected to the computation unit 101. The timer 118 may be a so-called real-time clock (RTC). The timer 118 can maintain date and time information. The timer 118 receives a constant supply of power from a battery (not shown) (e.g., a lithium ion battery). The timer 118 therefore can hold information even while the image forming apparatus 10 is not powered. The RTC may be implemented inside the computation unit 101.

In the first embodiment, it is assumed that the computation unit 101 cumulates power consumption (unit: watts) to obtain energy consumption (unit: watt-hours or watt-seconds) and presents the energy consumption to a user. Therefore, the computation unit 101 needs time information for identifying the period during which the power consumption was measured. For example, the computation unit 101 acquires time information from the timer 118 and stores the acquired time information in the volatile memory 103. The computation unit 101 uses the time information stored in the memory 103 to calculate the time between two given times. Generally, even when the image forming apparatus 10 transitions to a power saving state, the volatile memory 103 continues to receive power, and therefore the time information is not erased.

The operation unit 120 is connected to the computation unit 101 via an I/F 119. The operation unit 120 has a display (e.g., a liquid crystal display device) that displays the status of the image forming apparatus 10 to the user, and an input device (e.g., a panel-type touch sensor, hardware keys) that accepts various instructions from the user. The computation unit 101 displays the amount of power consumed by the image forming apparatus 10 on the display of the operation unit 120. A video signal provided by the computation unit 101 to the operation unit 120 is transmitted via, for example, a DisplayPort (DP) or a High Definition Multimedia Interface (HDMI (registered trademark)).

The scanner module 130 includes a control unit 131 and a drive unit 132. The control unit 131 controls the drive unit 132 to read an original placed on an original platen (not shown) and generate image data corresponding to the original. The drive unit 132 drives, for example, an automatic document feeder (ADF) to feed the original to the scanner module 130. The drive unit 132 drives a light emitting diode (LED) to illuminate the original, and drives an image sensor that converts the light from the original into color information.

The printer module 140 includes a control unit 141 and a drive unit 142. The control unit 141 controls the drive unit 142 to form images and characters on a recording medium. As shown in FIG. 5, the drive unit 142 drives, for example, a motor 501 that rotates a photosensitive drum, a charging power supply 502 that charges the photosensitive drum, and an exposure device 503 that irradiates the photosensitive drum with light to form an electrostatic latent image. The drive unit 142 drives a development power supply 504 that develops the electrostatic latent image using toner to form a toner image, a primary transfer power supply 505 that transfers the toner image from the photosensitive drum to an intermediate transfer body, and a secondary transfer power supply 506 that transfers the toner image from the intermediate transfer body to a recording medium.

The fixing module 150 has a fixing roller (or a cylindrical heating film) and a pressure roller, and applies heat and pressure to the recording medium onto which the toner image has been transferred. As a result, the toner image is fixed onto the recording medium.

A power supply 190 is a power supply device that converts alternating current supplied from an AC power supply into direct current. The power supply circuit 191 supplies DC voltage from the power supply 190 to various loads implemented on the board 110a. The loads include, for example, the controller module 100, the scanner module 130, the printer module 140, and the fixing module 150.

The control unit 111 controls the supply of power to the controller module 100. The control unit 111 is realized by, for example, a circuit element called a complex programmable logic device (CPLD). The circuit element implemented as the control unit 111 need only be a circuit element whose internal circuitry can be freely designed. Therefore, a field programmable gate array (FPGA) or the like may be employed in place of a CPLD or in addition to a CPLD. The control unit 111 also contributes to expanding the input/output (I/O) capability of the computation unit 101. For example, the control unit 111 acquires level information or type identification information that corresponds to the board type through the extended I/O capability. The level information may include, for example, combinations of voltage levels that differ according to the type of board.

FIG. 1B is a diagram illustrating the configuration of an image forming apparatus 10 having a type B board 110b. In order to efficiently produce various image forming apparatuses 10 that have different specifications or performance, the different types of boards 110a and 100b are designed. Various types of boards are designed by omitting some semiconductor chips or adopting higher performance semiconductor chips. As shown in FIG. 1B, the control unit 131 and the drive unit 132 of the scanner module 130, and the control unit 141 and the drive unit 142 of the printer module 140 are implemented on the board 110b. As shown in FIG. 1A, the control unit 131 and the drive unit 132 of the scanner module 130, and the control unit 141 and the drive unit 142 of the printer module 140 are implemented independently of the board 110a. Therefore, the power consumption value of the board 110a is different from the power consumption value of the board 110b. Therefore, there is desire for the ability to optimize the method of calculating the energy consumption according to the types of the boards 110a and 100b.

### 2. User Interface (UI)

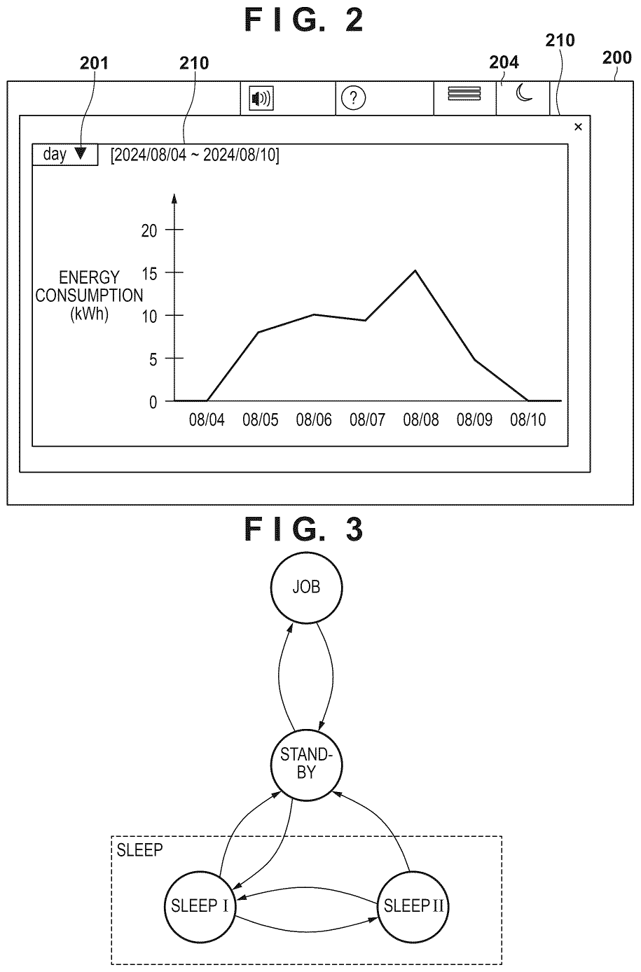

FIG. 2 shows an example of a UI 200 displayed on the operation unit 120. The UI 200 has an icon 204 indicating the power state or the operation state of the image forming apparatus 10 and a graph display area 210 displaying the energy consumption of the image forming apparatus 10. The computation unit 101 cumulates the energy consumption of the image forming apparatus 10 over a predetermined statistical period as a unit of time. A tab 201 is a designation object for designating the statistical period. Specifically, the tab 201 can be used to switch the position of the predetermined statistical period on the time axis or the length of the predetermined statistical period. The designation object may be realized by a pull-down list displaying a list of units of time. In FIG. 2, “day” is specified as the statistical period in the tab 201. Therefore, the computation unit 101 calculates the energy consumption by cumulating the power consumption value for each day, creates a graph showing change in the energy consumption over one week, and displays the graph in the graph display area 210. According to the user selection result in the tab 201, the computation unit 101 may switch the energy consumption to a cumulative value for one day, one week, or one month, and display the result on the operation unit 120. In other words, the computation unit 101 switches the energy consumption statistical period based on the selection result in the tab 201.

When the image forming apparatus 10 is installed in a customer's room, the computation unit 101 may create power consumption value log data and store the log data in the non-volatile memory 104. As a result, the computation unit 101 may refer to the log data, cumulate the power consumption values (W) for a specified statistical period (cumulation period), and display the energy consumption (Wh) on the operation unit 120. For example, the date on which the image forming apparatus 10 is installed in the customer's room may be specified as the start date of the statistical period, and “today” may be specified as the end date of the statistical period. In this manner, the statistical period may be selected by the user, or may be determined in advance.

The operation unit 120 may display the energy consumption for each of the function modules that configure the image forming apparatus 10. For example, the energy consumption of the controller module 100 and the energy consumption of the fixing module 150 may be displayed in separate columns or as separate graphs.

### 3. Power Consumption Cumulating Method (Energy Consumption Calculation Method)

FIG. 3 is a diagram illustrating state transitions that occur between power states. Here, the image forming apparatus 10 has a plurality of power states. The job state (JOB) is a state in which printing or scanning is being executed. The standby state (STANDBY) is a state in which the image forming apparatus 10 is waiting for a job. The sleep state (SLEEP) is a state in which the image forming apparatus 10 is operating with reduced power consumption. Note that the sleep state (SLEEP) may include a plurality of sleep states (e.g., SLEEP I, SLEEP II) in each of which the power consumption is different. SLEEP I and SLEEP II are sub states of the sleep state. Note that the power consumption in SLEEP II is lower than the power consumption in SLEEP I.

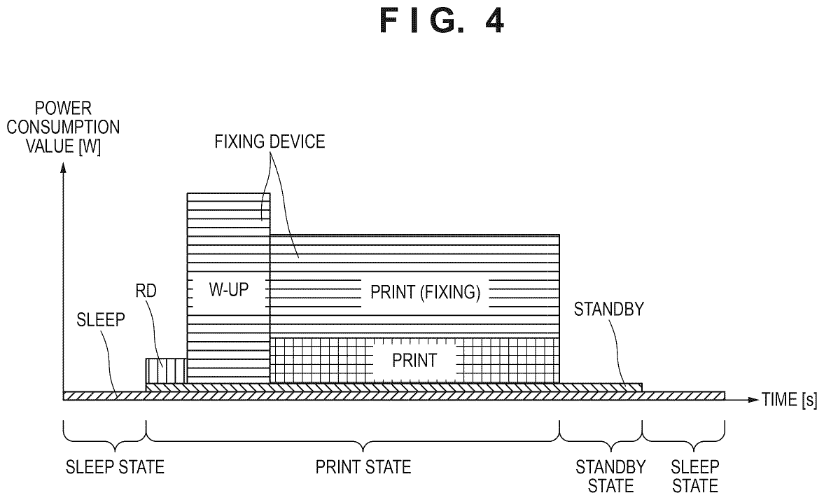

FIG. 4 shows power consumption values Pm (W) and energy consumption Wm (Wh) for the various power states. The horizontal axis indicates time. The vertical axis indicates the power consumption value Pm. The area of a hatched rectangle indicates the energy consumption Wm (Wh).

The power consumption value Pm and the energy consumption Wm are very small in the sleep state. However, the loads (communication circuit, etc.) that operate in the sleep state also operate in the job state and standby state. When a copy job is input to the image forming apparatus 10, the image forming apparatus 10 transitions from the sleep state to the job state. The scanner module 130 executes original reading. The power consumption value Pm and the energy consumption Wm during scanning of an original are denoted as RD. The loads that operate in the standby state (the operation unit 120, etc.) also operate in the job state. The power consumption value Pm and the energy consumption Wm of such loads are indicated as STANDBY. When the reading of the original is completed, the fixing module 150 is woken up. The power consumption value Pm and the energy consumption Wm at this time are indicated as W-UP. When wake-up of the fixing module 150 is completed, image formation is executed on a recording medium. PRINT indicates the power consumption of the printer module 140 and the like. PRINT (fixing) indicates the power consumption value Pm and the energy consumption Wm of the fixing module 150. When the copy job is completed, the image forming apparatus 10 transitions from the job state to the standby state. Furthermore, if the length (time) of the period during which a successive job has not been input in the standby state exceeds a threshold, the image forming apparatus 10 transitions from the standby state to the sleep state.

For each of the function modules, the computation unit 101 integrates (cumulates) the power consumption values Pm of the function module along the time axis to obtain the energy consumption Wm of the function module, and adds up the results for the function modules to obtain a total energy consumption WA. In other words, the total value of the areas of the plurality of rectangles shown in FIG. 4 indicates the total energy consumption WA (Wh). Here, the unit of energy consumption is assumed to be watt-seconds (Ws).

The computation unit 101 controls the supply and stop of power to the function modules according to the operation state (power state) of the image forming apparatus 10. Therefore, the energy consumption changes over time. The computation unit 101 can calculate the overall energy consumption of the image forming apparatus 10 by integrating (cumulating) the energy consumption of each of the function modules along the time axis.

FIG. 5 shows an example of the function modules. Wm1 indicates the energy consumption of the scanner module 130. Wm2 indicates the energy consumption of the controller module 100. Note that Wm2 may vary according to the types of the boards 110a and 100b. Wm3 indicates the energy consumption of the fixing module 150. Wm4 indicates the energy consumption of the printer module 140. The printer module 140 includes the motor 501 for driving the photosensitive drum and conveying rollers, the charging power supply 502, the exposure device 503, the development power supply 504, the primary transfer power supply 505, and the secondary transfer power supply 506.

As has been described with reference to FIGS. 1A and 1B, the electronic components implemented on the board 110a are different from the electronic components implemented on the board 110b. In particular, the board 110a does not have the control unit 131 and the drive unit 132 of the scanner module 130, and does not have the control unit 141 and the drive unit 142 of the printer module 140. Therefore, the power consumption of the control unit 131 and the drive unit 132 of the scanner module 130 is included in the power consumption of the scanner module 130. Similarly, the power consumption of the control unit 141 and the drive unit 142 of the printer module 140 is included in the power consumption of the printer module 140. In other words, it is possible to accurately calculate the energy consumption of each of these function modules.

The board 110b has the control unit 131 and the drive unit 132 of the scanner module 130, and the control unit 141 and the drive unit 142 of the printer module 140. The energy consumption of the board 110b is calculated as the energy consumption of the controller module 100. Therefore, the energy consumption of the board 110b is likely to be greater than the energy consumption of the board 110a. Therefore, unless the board 110a and the board 110b are correctly distinguished from each other when calculating the energy consumption is calculated, the energy consumption calculation result will contain an error.

There also are other cases where the energy consumption of the controller module 100 increases. For example, there may be a type A board 110a and a type C board that have the same number of integrated circuits (ICs) implemented thereon. However, the number of cores of the CPU implemented as the computation unit 101 of the type C board may be greater than the number of cores of the CPU implemented as the computation unit 101 of the type A board 110a. In this case, the energy consumption increases according to the number of cores.

As the capacity of the DRAM used in the volatile memory 103 increases, the energy consumption also increases. There are also other factors that can change the energy consumption. Therefore, the type of board needs to be taken into consideration when calculating the power consumption Wm2 of the controller module 100.

The computation unit 101 calculates the energy consumption WA by adding up Wm1 to Wm4. The computation unit 101 may calculate the energy consumption WA (Ws) by cumulating the total values of the power consumption Pm1 to Pm4 along the time axis. In other words, the computation unit 101 can calculate the cumulative energy consumption of the image forming apparatus 10 by cumulating the energy consumption WA calculated based on the power state of the image forming apparatus 10 over a predetermined time (e.g., one day, one week, one month).

4. Functions of computation unit

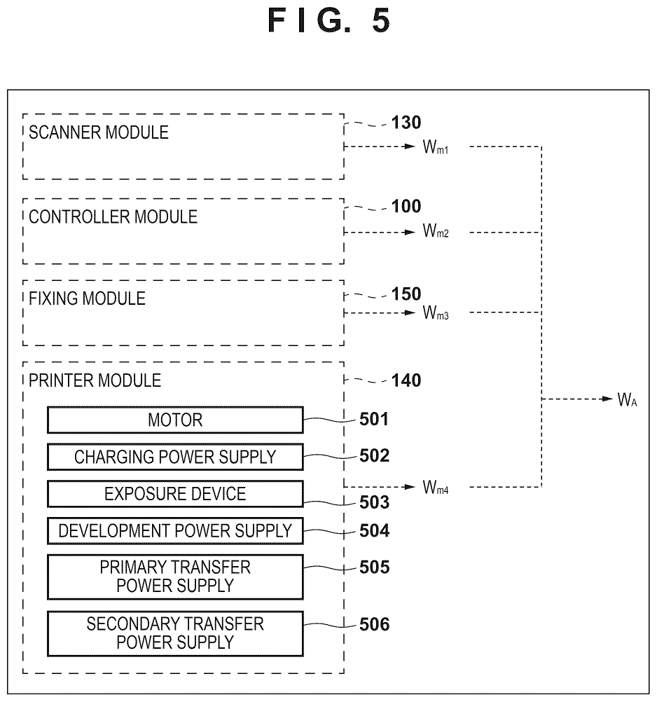

FIG. 6 shows functions of the computation unit 101. The computation unit 101 is connected to the volatile memory 103, the non-volatile memory 104, the timer 118, the operation unit 120, and the control units 107 and 111. The computation unit 101 performs communication with a PC or a server computer via the control unit 107 and the I/F 108. A battery 680 supplies power to the memory 104.

Based on the level information acquired from the control unit 111, an identification unit 600 identifies or determines the type of the board 110a or 100b on which the computation unit 101 is implemented. The identification unit 600 may refer to a first table 641 based on the level information acquired from the control unit 111, and identify the type (type identification information) of the board 110a or 100b. The identification unit 600 executes type identification processing when, for example, the image forming apparatus 10 is started up. Note that the level information and the type identification information may be different from each other or may be the same.

A setting unit 601, which is optional, downloads the first table 641 and a second table 642 from a server computer and stores the tables in the memory 104. A monitoring unit 602 monitors the power state of the image forming apparatus 10 and provides the monitoring result to individual acquisition units 610.

The individual acquisition units 610 acquire the power consumption value Pm or the energy consumption Wm of corresponding function modules. A Wm1 acquisition unit 611 acquires the power consumption of the scanner module 130. For example, the Wm1 acquisition unit 611 acquires a fixed value indicating the power consumption of the scanner module 130, which is stored in the non-volatile memory 104. The Wm1 acquisition unit 611 may acquire a power consumption value or an energy consumption calculated by the control unit 131 in the scanner module 130.

A Wm2 acquisition unit 612 acquires the power consumption value or the energy consumption of the controller module 100 according to the type of board identified by the identification unit 600. For example, the Wm2 acquisition unit 612 may acquire, from the second table 642, the power consumption value that corresponds to the combination of the identified board type and the power state. The Wm2 acquisition unit 612 calculates the energy consumption Wm2 of the controller module 100 by cumulating the power consumption value over a predetermined cumulation period.

A Wm3 acquisition unit 614 acquires the power consumption value of the fixing module 150. A Wm4 acquisition unit acquires the power consumption value of the printer module 140. The Wm3 acquisition unit 614 reads out a fixed value indicating the power consumption value of the fixing module 150, which is stored in the non-volatile memory 104. A Wm4 acquisition unit 615 reads out a fixed value indicating the power consumption value of the printer module 140, which is stored in the non-volatile memory 104. The Wm3 acquisition unit 614 may acquire a power consumption value calculated by a control unit provided inside the fixing module 150 as the power consumption value of the fixing module 150. The Wm4 acquisition unit may acquire the power consumption value calculated by the control unit 141 provided inside the printer module 140.

For each function module, a cumulation unit 620 adds up the power consumption values or energy consumption acquired by the individual acquisition unit 610 to calculate the total energy consumption WA. Furthermore, the cumulation unit 620 calculates the cumulative energy consumption of the image forming apparatus 10 by cumulating the energy consumption WA along the time axis for a specific period of time. A display control unit 630 creates the UI 200 for displaying the cumulative energy consumption, and displays the UI 200 on the display of the operation unit 120.

### 5. Board Type Identification Method

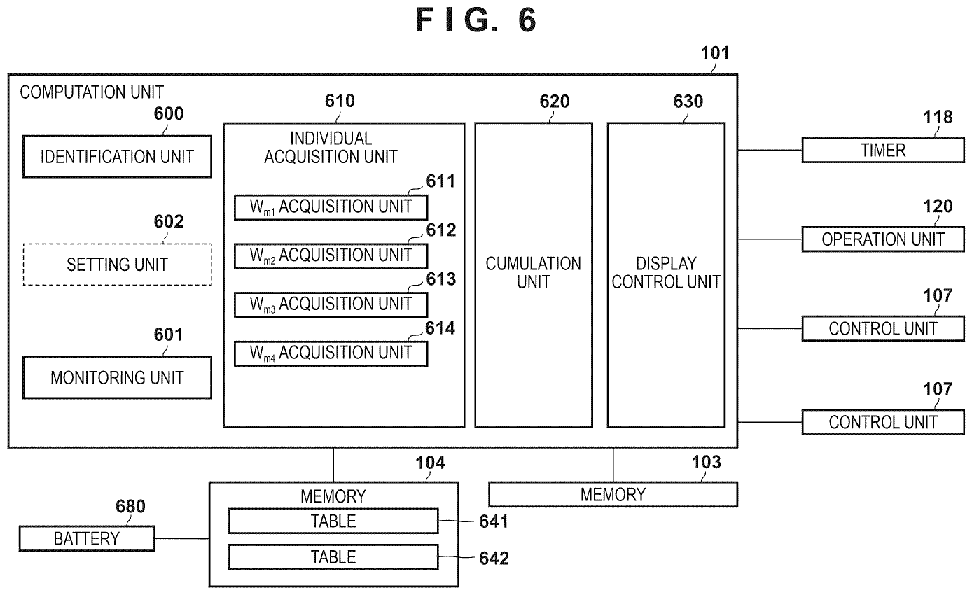

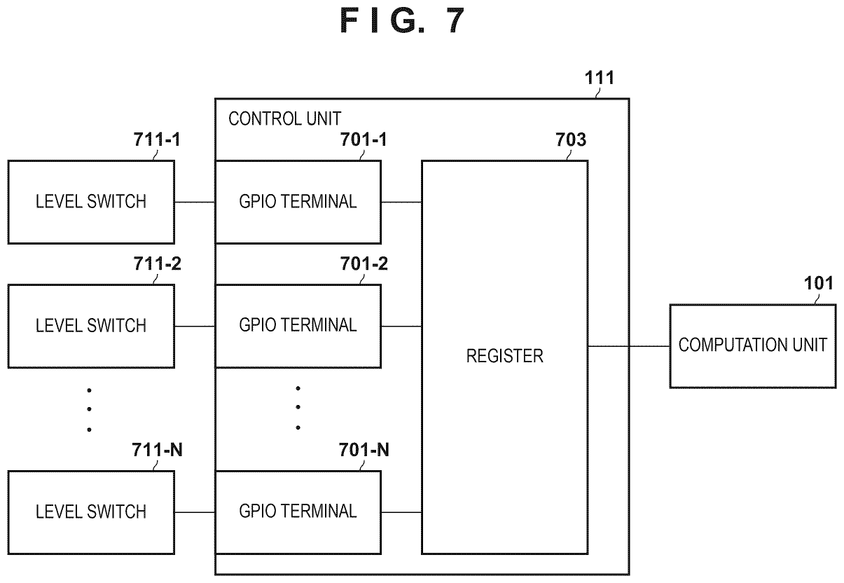

FIG. 7 shows the control unit 111 in detail. The control unit 111 has a plurality of (N) GPIO terminals 701-1 to 701-N. N is an integer of 2 or more. Note that if there are only two types of boards, a configuration is possible in which one GPIO terminal is provided on the board. GPIO is an abbreviation for general purpose input/output. N is, for example, an integer of 2 or more. The GPIO terminals 701-1 to 701-N can be used for inputting and outputting digital signals. A register 703 is connected to the GPIO terminals 701-1 to 701-N. In the case where the GPIO terminals 701-1 to 701-N are used as input terminals, the register 703 holds terminal information (e.g., level information) for each of the GPIO terminals 701-1 to 701-N. The register 703 is connected to the computation unit 101 via, for example, a serial peripheral interface (SPI) bus. The computation unit 101 reads information stored in the register 703 to acquire the terminal information of the GPIO terminals 701-1 to 701-N.

Level switches 711-1 to 711-N are used to switch the voltage level input to the GPIO terminals 701-1 to 701-N between High (high level) and Low (low level). The terminal information is expressed by switching the level switches 711-1 to 711-N between High and Low. The terminal information for the N level switches 711-1 to 711-N can be expressed by N bits.

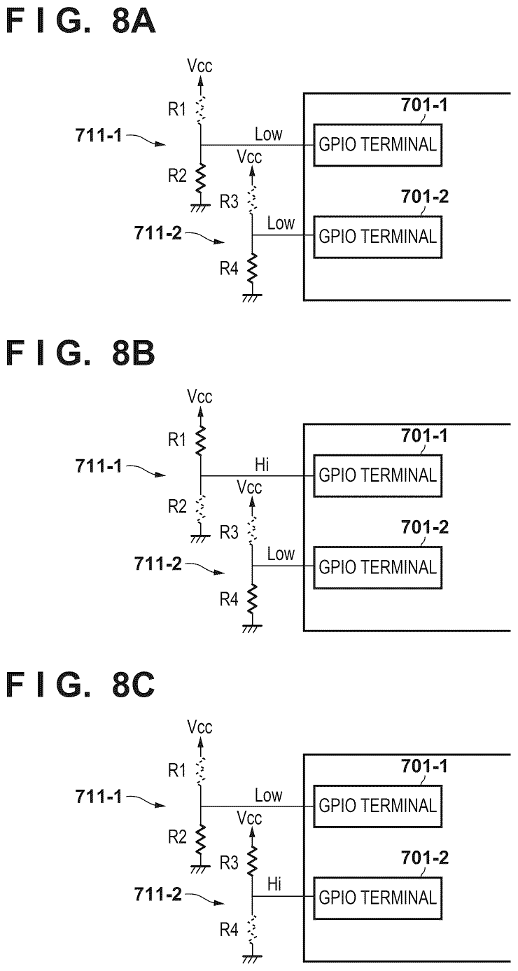

FIGS. 8A to 8C show the level switches 711-1 and 711-2 in the case where N=2. The level switch 711-1 is realized by a combination of a resistor R1 and a resistor R2. The resistor R1 and the resistor R2 are, for example, surface mountable chip resistors. Vcc indicates the power supply voltage supplied from the power supply circuit 191, or the power supply terminal (power supply line) that supplies the power supply voltage.

As shown in FIG. 8A, there are cases where the resistor R1 is not provided between the power supply voltage Vcc and the GPIO terminal 701-1, and the resistor R2 is provided between the ground terminal and the GPIO terminal 701-1. In this case, the voltage level of the GPIO terminal 701-1 is Low. The level switch 711-2 is realized by a combination of a resistor R3 and a resistor R4. There are cases where the resistor R3 is not provided between the power supply voltage Vcc and the GPIO terminal 701-2, and the resistor R4 is provided between the ground terminal and the GPIO terminal 701-2. In this case, the voltage level of the GPIO terminal 701-2 is Low. Therefore, “00” is stored in the register 703 as the terminal information or the level information.

As shown in FIG. 8B, there are cases where the resistor R1 is provided between the power supply voltage Vcc and the GPIO terminal 701-1, and the resistor R2 is not provided between the ground terminal and the GPIO terminal 701-1. In this case, the voltage level of the GPIO terminal 701-1 is High. There are cases where the resistor R3 is not provided between the power supply voltage Vcc and the GPIO terminal 701-2, and the resistor R4 is provided between the ground terminal and the GPIO terminal 701-2. In this case, the voltage level of the GPIO terminal 701-2 is Low. Therefore, “10” is stored in the register 703 as the terminal information or the level information.

As shown in FIG. 8C, there are cases where the resistor R1 is not provided between the power supply voltage Vcc and the GPIO terminal 701-1, and the resistor R2 is provided between the ground terminal and the GPIO terminal 701-1. In this case, the voltage level of the GPIO terminal 701-1 is Low. There are cases where the resistor R3 is provided between the power supply voltage Vcc and the GPIO terminal 701-2, and the resistor R4 is not provided between the ground terminal and the GPIO terminal 701-2. In this case, the voltage level of the GPIO terminal 701-2 is High. Therefore, “01” is stored in the register 703 as the terminal information or the level information.

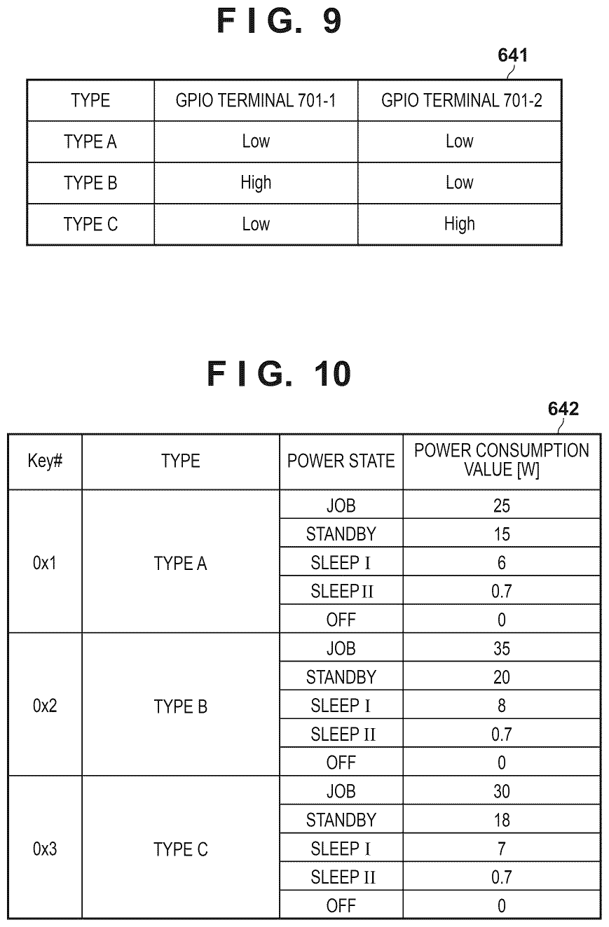

FIG. 9 shows an example of the first table 641. The first table 641 shows board types each identified by a combination of the signal level of the GPIO terminal 701-1 and the signal level of the GPIO terminal 701-2. When the signal level of the GPIO terminal 701-1 is Low and the signal level of the GPIO terminal 701-2 is low, the type of the board is identified as type A. When the signal level of the GPIO terminal 701-1 is High and the signal level of the GPIO terminal 701-2 is Low, the type of the board is identified as type B. When the signal level of the GPIO terminal 701-1 is Low and the signal level of the GPIO terminal 701-2 is High, the type of the board is identified as type C.

In this way, the signal levels of the GPIO terminals 701-1 to 701-N can be switched by the corresponding level switches 711-1 to 711-N. This makes it possible to identify the type of board. Although the GPIO terminals 701-1 to 701-N are implemented in the control unit 111 here, this is merely one example. The GPIO terminals 701-1 to 701-N may be implemented in the computation unit 101.

The computation unit 101 accesses the register 703 in the control unit 111 via the SPI bus. Addresses are assigned to storage areas of the register 703. The computation unit 101 knows the addresses corresponding to the GPIO terminals 701-1 to 701-N, and can read the terminal information from the register 703 according to the addresses. Moreover, a combination of the read terminal information forms the type identification information.

### 6. Acquisition of Power Consumption Information Corresponding to Combination of Board Type and Power State

FIG. 10 shows an example of the second table 642. The second table 642 stores pieces of power consumption information of the controller module 100 corresponding to combinations of board types and power states. As shown in FIG. 10, the power consumption value Pm of the controller module 100 varies greatly according to the combination of the power state of the image forming apparatus 10 and the type of board. For example, when the type of the board is type A and the power state is JOB, the power consumption value is 25 (W). When the type of the board is type A and the power state is STANDBY, the power consumption value is 15 (W). When the type of the board is type A and the power state is SLEEP I, the power consumption value is 6 (W). When the type of the board is type A and the power state is SLEEP II, the power consumption value is 0.7 (W). When the type of the board is type A and the power state is OFF, the power consumption value is 0 (W).

When the type of the board is type B and the power state is JOB, the power consumption value is 35 (W). When the type of the board is type B and the power state is STANDBY, the power consumption value is 20 (W). When the type of the board is type B and the power state is SLEEP I, the power consumption value is 8 (W). When the type of the board is type B and the power state is SLEEP II, the power consumption value is 0.7 (W). When the type of the board is type B and the power state is OFF, the power consumption value is 0 (W).

When the type of the board is type C and the power state is JOB, the power consumption value is 30 (W). When the type of the board is type B and the power state is STANDBY, the power consumption value is 18 (W). When the type of the board is type B and the power state is SLEEP I, the power consumption value is 7 (W). When the type of the board is type B and the power state is SLEEP II, the power consumption value is 0.7 (W). When the type of the board is type B and the power state is OFF, the power consumption value is 0 (W).

The first power saving state (SLEEP I) is a state in which the backlight of the operation unit 120 is turned off and power is not supplied to the conversion unit 160. In other words, in the first power saving state, various devices actively reduce power consumption by performing clock gating or power gating.

The second power saving state (SLEEP II) is a state in which power is supplied only to the volatile memory 103, the control unit 107, the timer 118, an interrupt control unit, and the touch sensor provided in the operation unit 120. The interrupt control unit is provided in the computation unit 101. In the second power saving state, the volatile memory 103 is in a so-called self-refresh state. The control unit 107 uses a function called proxy response to filter out unnecessary packets received from the outside. The first power saving state and the second power saving state may be alternatively selected by the user. For example, if power saving is to be prioritized, the second power saving state is selected. If priority is to be given to shortening the time required for returning from the sleep state to the standby state, the first power saving state is selected.

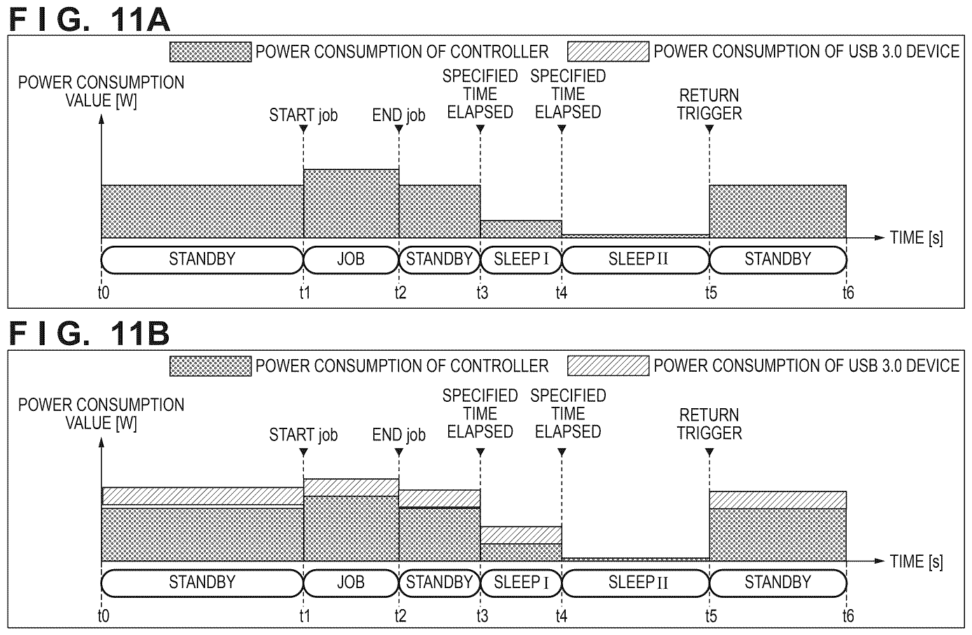

FIG. 11A shows a cumulative energy consumption calculating method for the energy consumption Wm2 of the controller module 100 having the board 110a. The vertical axis indicates the power consumption value. The horizontal axis indicates time. The hatched rectangles indicate the energy consumption. The power state during the period from time t0 to time t1 is STANDBY. The power state during the period from time t1 to time t2 is JOB. The power state during the period from time t2 to time t3 is STANDBY. The power state during the period from time t3 to time t4 is SLEEP I. The power state during the period from time t4 to time t5 is SLEEP II. The power state during the period from time t5 to time t6 is STANDBY.

The computation unit 101 starts calculating the energy consumption from time t0. The start point may be, for example, the time when the user touches the tab 201 or the time when the image forming apparatus 10 is installed in the user's room.

When the image forming apparatus 10 is started up, the computation unit 101 reads the type identification information from a register 117 and determines the type of the board on which the computation unit 101 is implemented. The type identification processing is executed before time t0. The Wm2 acquisition unit 612 refers to the first table 641 in the non-volatile memory 104 based on the type identification information, and identifies the type corresponding to the type identification information. Here, it is assumed that the type identification information indicates type A.

At time t0, the power state of the image forming apparatus 10 is STANDBY. The Wm2 acquisition unit 612 refers to the second table 642 in the non-volatile memory 104. Key #0x1 corresponding to type A is referenced. Furthermore, since the power state is STANDBY, 15 (W) is acquired as the power consumption value of the type A board 110a. The computation unit 101 may refer to the second table 642 deployed to the volatile memory 103. The cumulation unit 620 executes energy consumption cumulation using 15 (W) as the power consumption value of the board 110a during the period from time t0 to time t1. A cumulative energy consumption Wt01 from time t0 to time t1 can be calculated using the following equation.

$$W t 01 = 15 \times ( t 1 - t 0 ) \qquad Eq . 1$$

The computation unit 101 acquires the actual value of time t from the timer 118. The computation unit 101 may count the elapsed time by a program running on the computation unit 101.

At time t1, the user instructs the image forming apparatus 10 to execute a job. For example, execution of a print job is instructed via a wired LAN. As a result, the computation unit 101 switches the power state of the image forming apparatus 10 from STANDBY to JOB. When a change in the power state of the image forming apparatus 10 is detected, the Wm2 acquisition unit 612 refers to Key #0x1 in the second table 642. Accordingly, 25 (W) is obtained as the power consumption value that corresponds to the combination of type A and JOB.

The cumulation unit 620 adds up these power consumption values to calculate a cumulative value for the period from time t1 to time t2. A cumulative power consumption value Wt12 for the period from time t1 to t2 can be calculated using the following equation.

$$Wt 12 = 25 \times ( t 2 - t 1 ) \qquad Eq . 2$$

When the job ends at time t2, the power state of the image forming apparatus 10 transitions from JOB to STANDBY. When the monitoring unit 602 detects a change in the power state of the image forming apparatus 10, the Wm2 acquisition unit 612 refers to Key #0x1 in the second table 642. Accordingly, 15 (W) is obtained as the power consumption value that corresponds to the combination of type A and STANDBY. The cumulation unit 620 calculates a cumulative value for the period from time t2 to time t3. In other words, a cumulative power consumption value Wt23 for the period from time t2 to time t3 can be calculated using the following equation.

$$Wt 23 = 15 \times ( t 3 - t 2 ) \qquad Eq . 3$$

Time t3 is the timing when a specified time has elapsed since time t2 when the power state transitioned from JOB to STANDBY. The timer 118 notifies the computation unit 101 that the specified time has elapsed. In other words, the computation unit 101 uses the timer 118 to measure the specified time. At time t3, the computation unit 101 transitions the power state from STANDBY to SLEEP I (first power saving state). This reduces power consumption. When a change in the power state of the image forming apparatus 10 is detected, the Wm2 acquisition unit 612 refers to Key #0x1 in the second table 642. Accordingly, 6 (W) is obtained as the power consumption value that corresponds to the combination of type A and SLEEP I. The cumulation unit 620 calculates a cumulative value for the period from time t3 to time t4. In other words, a cumulative power consumption value Wt34 from time t3 to t4 can be calculated using the following equation.

$$Wt 34 = 6 \times ( t 4 - t 3 ) \qquad Eq . 4$$

Time t4 is the timing when a specified time has further elapsed from time t3. When the timer 118 notifies the computation unit 101 that the specified time has elapsed, the computation unit 101 transitions the power state of the image forming apparatus 10 from the first power saving state to SLEEP II (second power saving state). When the monitoring unit 602 detects a change in the power state of the image forming apparatus 10, the Wm2 acquisition unit 612 refers to Key #0x1 in the second table 642. Accordingly, 0.7 (W) is obtained as the power consumption value that corresponds to the combination of type A and SLEEP II. The cumulation unit 620 calculates a cumulative value for the period from time t4 to time t5. In other words, a cumulative power consumption value Wt45 for the period from time t4 to time t5 can be calculated using the following equation.

$$Wt 45 = 0.7 \times ( t 5 - t 4 ) \qquad Eq . 5$$

At time t5, the user inputs a return trigger for the image forming apparatus 10. One example of the return trigger is when the user touches the touch sensor of the operation unit 120. As a result, the computation unit 101 transitions the power state of the image forming apparatus 10 from SLEEP II to STANDBY. When the monitoring unit 602 detects a change in the power state of the image forming apparatus 10, the Wm2 acquisition unit 612 refers to Key #0x1 in the second table 642. Accordingly, 15 (W) is obtained as the power consumption value that corresponds to the combination of type A and STANDBY. The cumulation unit 620 calculates a cumulative value for the period from time t5 to time t6. In other words, a cumulative power consumption value Wt56 for the period from time t5 to time t6 can be calculated using the following equation.

$$Wt 56 = 15 \times ( t 6 - t 5 ) \qquad Eq . 6$$

FIG. 11B shows a cumulative energy consumption calculating method for the energy consumption Wm2 of the controller module 100 having the type B board 110b. The identification unit 600 identifies the type of the board 110b as type B. Therefore, the Wm2 acquisition unit 612 refers to Key #0x2 in the second table 642. In this way, the power consumption value that corresponds to the power state and the type of the board 110b is acquired. As shown in FIG. 10, the power consumption value of the board 110b is greater than the power consumption value of the board 110a. Therefore, as shown in FIG. 11B, the energy consumption of the board 110b is greater than the energy consumption of the board 110a. The method of calculating the energy consumption for the board 110b is the same as that described with reference to FIG. 11A, except that Key #0x1 is replaced with Key #0x2. Note that the description for when the type of board is type C is the same as that for FIG. 11A, except that Key #0x1 is replaced with Key #0x3.

### 7. Flowchart

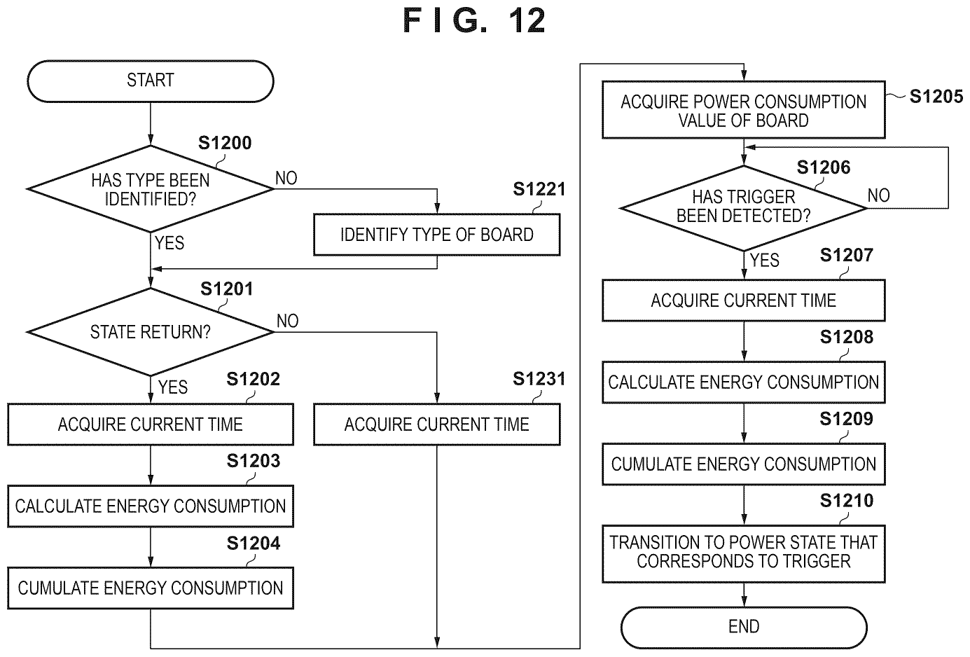

FIG. 12 shows a control method executed by the computation unit 101 in accordance with a control program. Here, when the power state of the image forming apparatus 10 changes, the following processing is executed.

In step S1200, the computation unit 101 accesses the register 703 of the control unit 111 and attempts to read the level information (type identification information) in order to determine whether or not the type of the board has been identified. As described above, when the image forming apparatus 10 is started up, type identification information, which is a combination of level information, is stored in the register 703. If the type of the board has not been specified, the computation unit 101 moves from step S1200 to step S1221 to identify the type of the board. For example, the computation unit 101 causes the control unit 111 to determine the voltage levels of the GPIO terminals 701-1 to 701-N and store the determination result in the register 703. Thereafter, the computation unit 101 moves from step S1221 to step S1201. If it is determined in step S1200 that the type has already been identified, the computation unit 101 moves from step S1200 to step S1201.

In step S1201, the computation unit 101 determines whether or not the power state of the image forming apparatus 10 has returned from the second power saving state to the first power saving state or the standby state. If the second power saving state continues, the computation unit 101 moves from step S1201 to step S1231 and acquires the current time from the timer 118. Thereafter, the computation unit 101 moves from step S1231 to step S1205. If the power state has returned from the second power saving state to another state, the computation unit 101 moves from step S1201 to step S1202.

In step S1202, the computation unit 101 acquires the current time from the timer 118. In step S1203, the computation unit 101 calculates the amount of energy consumed between the previously acquired time and the current time. These times are the times when state transitions occurred. In other words, a specific power state is maintained during the period between the previously acquired time and the current time.

In step S1204, the computation unit 101 cumulates the calculated energy consumption. The result is added to the cumulative energy consumption. In the second power saving state, the computation unit 101 does not receive power and therefore cannot execute energy consumption calculation. Therefore, after the power state has returned from the second power saving state to another state, the energy consumption during the period in which the device was in the second power saving state is calculated. Time information indicating the current time may be stored in either the volatile memory 103 or the non-volatile memory 104. In the first embodiment, the time information is stored in the volatile memory 103.

In step S1205, the computation unit 101 acquires, from the non-volatile memory 104, the power consumption value of the board that matches the current power state of the image forming apparatus 10. For example, the computation unit 101 refers to the second table 642 in the non-volatile memory 104 and acquires the power consumption value that corresponds to the combination of the current power state and the type of board.

In step S1206, the computation unit 101 determines whether or not a trigger has been detected. Here, the trigger may be any trigger that brings about a change in the power state. If a trigger is detected, the computation unit 101 moves from step S1206 to step S1207.

In step S1207, the computation unit 101 acquires the current time from the timer 118. This time is the time the trigger was detected.

In step S1208, the computation unit 101 acquires, from the memory 104, the power consumption value that corresponds to the current power state, and calculates the energy consumption during the period from the previous time to the current time. The computation unit 101 refers to the second table 642 and acquires the power consumption value that corresponds to the combination of the current power state and the type of board.

In step S1209, the computation unit 101 adds the energy consumption during the period from the previous time to the current time to the cumulative energy consumption. Since it is necessary to calculate the cumulative energy consumption, the energy consumption in the specific period of time is added to the cumulative energy consumption up to that point. The cumulative energy consumption is stored in the non-volatile memory 104. The cumulative energy consumption may be stored in the volatile memory 103. In this case, the cumulative energy consumption may be written from the memory 103 to the memory 104 when the power state transitions to the second power saving state and when the power state transitions to power OFF. In other words, the writing of the cumulative energy consumption to the memory 104 may be performed as part of suspend processing or shutdown processing.

In step S1210, the computation unit 101 transitions to the power state that corresponds to the trigger.

According to the first embodiment, the identification unit 600 identifies the types of the boards 110a and 110b. The second table 642 functions as a storage unit that stores power consumption information corresponding to a plurality of different types of boards. The computation unit 101 acquires the power consumption information that corresponds to the type of the boards 110a and 110b from the second table 642, and calculates the energy consumption of the image forming apparatus 10 based on the power consumption information. Therefore, according to the first embodiment, the power consumption value of the controller module 100 is acquired more accurately by taking the types of the boards into consideration. As a result, the power consumption value WA of the image forming apparatus 10 can be calculated with high accuracy. Furthermore, since the power consumption values of the boards are acquired without using a current sensor, it is possible to more easily calculate the energy consumption of the image forming apparatus.

As illustrated in FIGS. 1A and 1B, the circuit components (e.g., resistors R1 to R4, SW1, SW2) implemented on the boards 110a and 110b may be different according to the type of board. The identification unit 600 may identify the type of board based on the circuit components. For example, the identification unit 600 may identify the type of board based on the combination of circuit components implemented on the boards 110a and 110b. The identification unit 600 may identify the type based on the electrical characteristics or electrical states of the circuit components implemented on the boards 110a and 110b.

For example, a circuit component may have one or more terminals (e.g., the GPIO terminals 701-1 to 701-N). The identification unit 600 may identify the type based on the electrical characteristics or electrical states of one or more terminals. As shown in FIG. 7, the one or more terminals may be the GPIO terminals 701-1 to 701-N. The identification unit 600 may identify the type based on whether or not a resistor is connected to the GPIO terminals 701-1 to 701-N, or based on the resistance value of the resistor connected to the GPIO terminals 701-1 to 701-N. Note that the case where no resistor is connected to the GPIO terminals 701-1 to 701-N is equivalent to the case where a resistor having an infinite resistance value is connected to the GPIO terminals 701-1 to 701-N. The resistors R2 and R4 may be connected between the ground terminal and the GPIO terminals 701-1 to 701-N. The resistors R1 and R3 may be connected between the power supply terminal and the GPIO terminals 701-1 to 701-N. The electrical state may be a high level or a low level at each of one or more terminals. The register 703 is an example of a holding unit that holds level information indicating the levels of one or more terminals. The identification unit 600 may identify the types of the boards 110a and 110b based on the level information held in the register 703.

As shown in FIG. 10, the memory 104 and the second table 642 may store power consumption information corresponding to combinations of a plurality of power states and types of boards.

As suggested by FIG. 12, the computation unit 101 may cumulate the energy consumption for each period during which a specific power state continues. This makes it easier to cumulate the energy consumption. As suggested in FIG. 2, the computation unit 101 may further obtain the energy consumption for each period during which a specific power state continues, and cumulate the energy consumption for each predetermined statistical period. The user may wish to know the energy consumption for each predetermined statistical period. For this reason, the cumulation period and the statistical period may be different.

As shown in FIG. 10, the power states may include JOB, STANDBY, SLEEP I, and SLEEP II. JOB is a power state in which the image forming apparatus 10 executes a job. STANDBY is a power state in which the image forming apparatus 10 waits for input of a job. SLEEP I and II are power states in which the image forming apparatus is in a sleep state. The power consumption value in SLEEP II is lower than the power consumption value in SLEEP I. The power consumption value in SLEEP I is lower than the power consumption value in STANDBY. The power consumption value in STANDBY is lower than the power consumption value in JOB. As shown in FIG. 10, the power consumption value of the external load in SLEEP II is lower than the power consumption value of the external load in SLEEP I.

As shown in FIG. 2, when displaying the cumulative value of the total values of the power consumption values of the internal loads and the power consumption values of the external loads, the display device of the operation unit 120 may display a cumulative value for each predetermined statistical period. This enables the user to more easily understand the overall power consumption of the image forming apparatus 10.

The tab 201 functions as a switching unit for switching the position of the predetermined statistical period along the time axis or the length of the predetermined statistical period. This enables the user to easily switch between statistical periods.

### Second Embodiment

According to the first embodiment, the level switches 711-1 to 711-N connected to the GPIO terminals 701-1 to 701-N are realized by the resistors R1 to R4. However, this is merely one example. Any combination of circuit components or combination of electrical characteristics or electrical states of circuit components that can be detected by the control unit 111 can be used as an embodiment.

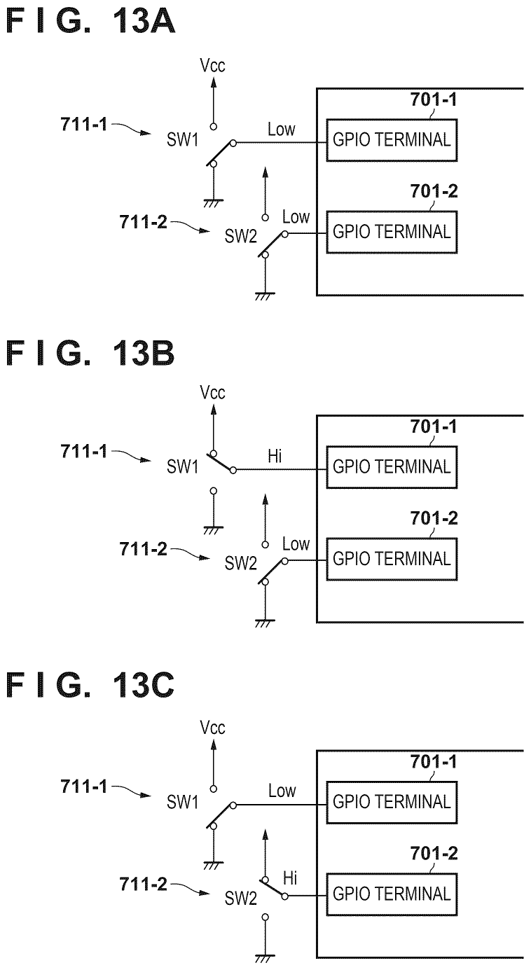

FIGS. 13A to 13C show examples in which the level switches 711-1 to 711-N are realized by switches SW1 and SW2. The switch SW1 switches between connecting the GPIO terminal 701-1 to the power supply voltage Vcc or to the ground terminal. Accordingly, the voltage level of the GPIO terminal 701-1 is switched to High or Low. The switch SW2 switches between connecting the GPIO terminal 701-2 to the power supply voltage Vcc or to the ground terminal. Accordingly, the voltage level of the GPIO terminal 701-2 is switched to High or Low.

In FIG. 13A, the GPIO terminal 701-1 is connected to the ground terminal by the switch SW1. Therefore, the voltage level of the GPIO terminal 701-1 is Low. The GPIO terminal 701-2 is connected to the ground terminal by the switch SW2. Therefore, the voltage level of the GPIO terminal 701-2 is Low.

In FIG. 13B, the GPIO terminal 701-1 is connected to power supply voltage Vcc by the switch SW1. Therefore, the voltage level of the GPIO terminal 701-1 is High. The GPIO terminal 701-2 is connected to the ground terminal by the switch SW2. Therefore, the voltage level of the GPIO terminal 701-2 is Low.

In FIG. 13C, the GPIO terminal 701-1 is connected to the ground terminal by the switch SW1. Therefore, the voltage level of the GPIO terminal 701-1 is Low. The GPIO terminal 701-2 is connected to the power supply voltage Vcc by the switch SW2. Therefore, the voltage level of the GPIO terminal 701-2 is High.

In this manner, the level switches 711-1 to 711-N may be realized by the switches SW1 and SW2. Note that other circuit components may be employed as long as they are circuit components capable of changing the terminal levels of the GPIO terminals 701-1 to 701-N.

### Variations

Although the case where the GPIO terminals 701-1 to 701-N are employed has been described, analog terminals may also be employed. An analog terminal is a terminal or port equipped with an analog-to-digital converter (ADC) and installed in a CPU or other device. The computation unit 101 has a plurality of terminals or ports, some of which may not have signals assigned thereto. In this case, the available terminals or ports may be used in place of or in addition to the GPIO terminals 701-1 to 701-N.

In the first embodiment, the level information is changed according to whether or not the resistors R1 to R4 are implemented. However, this is merely one example. A configuration is possible in which the resistors R1 to R4 are implemented, and level information is expressed by differences in the resistance values of the resistors R1 to R4. Each of the GPIO terminals 701-1 to 701-N has a threshold value for distinguishing between the High level and the Low level. Therefore, to express the High level, the resistance values of the resistors R1 to R4 may be selected so as to result in a voltage level greater than or equal to the threshold value. To express the Low level, the resistance values of the resistors R1 to R4 may be selected to result in a voltage level below the threshold value. The power supply voltage Vcc is divided by the resistance ratio of the resistor R1 and the resistor R2, and the divided voltage is applied to the GPIO terminal 701-1. Therefore, the level information is determined based on the resistance value of the resistor R1 and the resistance value of the resistor R2. This similarly applies to the resistors R3 and R4 and the GPIO terminal 701-2.

In the first embodiment, the first table 641 and the second table 642 are stored in the memory 104, but this is merely an example. The first table 641 and the second table 642 may be stored in a server computer (network storage) connected to a wired LAN or a wireless LAN. The computation unit 101 may access the server computer via the control unit 107 and the I/F 108 and refer to the first table 641 and the second table 642 or download the first table 641 and the second table 642 to the memory 104, for example.

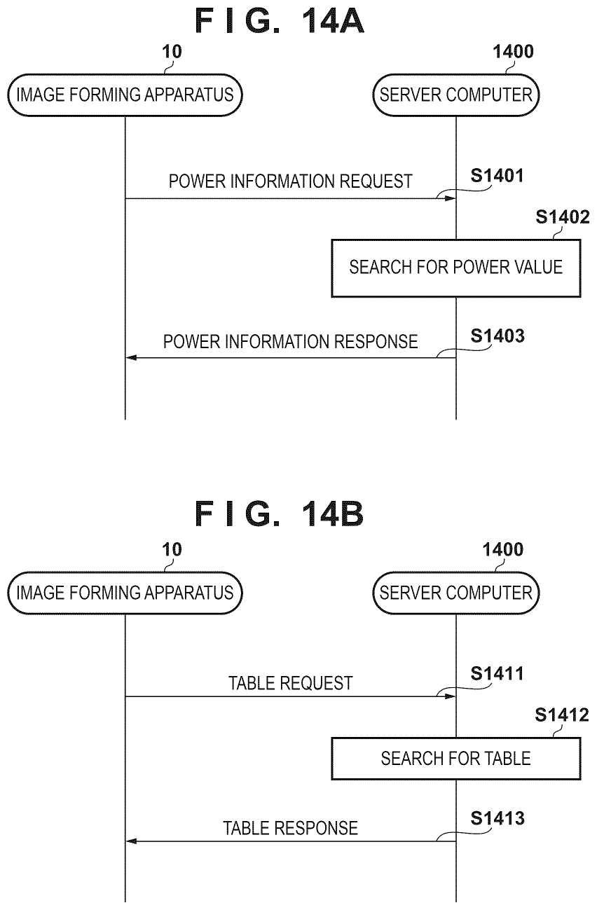

As shown in FIG. 14A, the computation unit 101 may acquire power consumption information of an external load from outside the image forming apparatus 10. A server computer 1400 is a network storage or a database server.

As described above, the server computer 1400, in an external network, may store the first table 641 and the second table 642. The server computer 1400 includes a CPU, a communication circuit, and a storage device (e.g., a RAM, a ROM, a hard disk drive, or a solid state drive). The storage device of the server computer 1400 stores the first table 641 and the second table 642.

In step S1401, the computation unit 101 accesses the server computer 1400 via the control unit 107 and the I/F 108, and transmits a request (query) for type identification information or power consumption information. Here, a request related to the first table 641 includes a combination of signal levels (a combination of the voltage levels of the GPIO terminals 701-1 to 701-N). A request related to the second table 642 includes the type identification information and the power state.

In step S1402, the server computer 1400 receives the request, and searches the second table 642 to extract the power consumption information that corresponds to the request. Alternatively, the server computer 1400 extracts the type identification information that corresponds to the combination of signal levels from the first table 641.

In step S1403, the server computer 1400 transmits the power consumption information or the type identification information that was found in the search to the image forming apparatus 10. The computation unit 101 stores the power consumption information or the type identification information received from the server computer 1400 in the memory 104 or the memory 103, and uses the information in energy consumption calculation.

As shown in FIG. 14B, the computation unit 101 may acquire at least either one of the first table 641 and the second table 642 from a device outside the image forming apparatus 10.

In step S1411, the computation unit 101 accesses the server computer 1400 via the control unit 107 and the I/F 108, and transmits a request for the first table 641 or the second table 642. Here, the request related to the first table 641 and the request related to the second table 642 may include identification information of the image forming apparatus 10. This is because the table may differ according to the model of the image forming apparatus 10.

In step S1412, the server computer 1400 receives the request, and searches for and extracts the first table 641 or the second table 642 that corresponds to the request.

In step S1413, the server computer 1400 transmits the first table 641 or the second table 642 found in the search to the image forming apparatus 10. The computation unit 101 stores the first table 641 or the second table 642 received from the server computer 1400 in the memory 104 or the memory 103, and uses the received table when calculating the energy consumption.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-189203, filed Oct. 28, 2024, which is hereby incorporated by reference herein in its entirety.

What is claimed is:

1. An image forming apparatus comprising:
a board;
an identification unit configured to identify a type of the board; and
a computation unit configured to acquire, from a storage unit storing a plurality of pieces of power consumption information in correspondence with a plurality of different types of boards, power consumption information corresponding to the type of the board identified by the identification unit, and calculate an energy consumption of the image forming apparatus based on the acquired power consumption information.

2. The image forming apparatus according to claim 1,
wherein the board has a circuit component implemented thereon according to the type of the board, and
the identification unit identifies the type of the board based on the circuit component.

3. The image forming apparatus according to claim 2, wherein the identification unit identifies the type of the board based on a combination of circuit components implemented on the board.

4. The image forming apparatus according to claim 2, wherein the identification unit identifies the type of the board based on an electrical characteristic or an electrical state of the circuit component implemented on the board.

5. The image forming apparatus according to claim 4,
wherein the circuit component has one or more terminals, and
the identification unit identifies the type of the board based on an electrical characteristic or an electrical state of the one or more terminals.

6. The image forming apparatus according to claim 5, wherein each of the one or more terminals is a general-purpose input/output (GPIO) terminal.

7. The image forming apparatus according to claim 6, wherein the identification unit identifies the type of the board based on whether a resistor is connected to the GPIO terminal, or based on a resistance value of the resistor connected to the GPIO terminal.

8. The image forming apparatus according to claim 7, wherein the resistor is connected between the GPIO terminal and a ground terminal, or is connected between the GPIO terminal and a power supply terminal.

9. The image forming apparatus according to claim 5, wherein the electrical state indicates whether a level of each of the one or more terminals is a high level or a low level.

10. The image forming apparatus according to claim 9, further comprising a holding unit configured to hold level information indicating a level of each of the one or more terminals,
wherein the identification unit identifies the type of the board based on the level information held in the holding unit.

11. The image forming apparatus according to claim 1,
wherein the image forming apparatus has a plurality of power states, and
the storage unit stores the plurality of pieces of power consumption information in correspondence with combinations of the plurality of power states and the types of boards.

12. The image forming apparatus according to claim 11, wherein the computation unit cumulates the energy consumption for each of a plurality of periods in which a specific power state among the plurality of power states continues, and cumulates the energy consumption cumulated for each period in which the specific power state continues for each of a plurality of predetermined statistical periods.

13. The image forming apparatus according to claim 11,
wherein the plurality of power states include a first state, a second state, and a third state,
the first state is a power state in which the image forming apparatus executes a job,
the second state is a power state in which the image forming apparatus waits for input of a job,
the third state is a power state in which the image forming apparatus is in a sleep state,
a power consumption value of the board in the third state is lower than the power consumption value of the board in the second state, and
the power consumption value of the board in the second state is lower than the power consumption value of the board in the first state.

14. The image forming apparatus according to claim 13,
wherein the plurality of power states further include a fourth state,
the fourth state is a power state in which the image forming apparatus is in a sleep state, and
the power consumption value of the board in the fourth state is lower than the power consumption value of the board in the third state.

15. The image forming apparatus according to claim 1, further comprising the storage unit.

16. The image forming apparatus according to claim 1, further comprising a communication unit configured to perform communication with a network storage,
wherein the storage unit is the network storage, and
the computation unit accesses the storage unit via the communication unit to acquire the power consumption information.

17. The image forming apparatus according to claim 1, further comprising a display unit configured to display a cumulative value regarding the energy consumption for each of a plurality of predetermined statistical periods.

18. The image forming apparatus according to claim 17, further comprising a switching unit configured to switch a position of the predetermined statistical period along a time axis and switch a length of the predetermined statistical period.
